(19) United States
(12) Patent Application Publication
(10) Pub. No.: US 2013/0019115 A1
(43) Pub. Date: Jan. 17, 2013

(54) IMAGE FORMING APPARATUS AND CONTROL METHOD

(71) Applicant: Michiaki NISHIMURA, Osaka (JP)

(72) Inventor: Michiaki NISHIMURA, Osaka (JP)

(73) Assignee: SHARP KABUSHIKI KAISHA, Osaka (JP)

(21) Appl. No.: 13/491,636

(22) Filed: Jun. 8, 2012

(30) Foreign Application Priority Data
Jul. 11, 2011 (JP) 2011-153111

(51) Int. Cl. G06F 1/32

(52) U.S. Cl. 713/323

(57) ABSTRACT

Provided is an image forming apparatus including a plurality of processing sections each performing a different process, a switching section for switching the status of the apparatus from a normal status to a power-saving status which requires power consumption smaller than that in the normal status when none of the plurality of processing sections performs processing for a predetermined period of time, a return section for making the status of the apparatus return from the power-saving status to the normal status under a predetermined condition, a pre-energizing section for energizing each of the processing sections in advance when the status of the apparatus is returned to the normal status, a specifying section for specifying a process to be executed, and a stop section for selectively stopping pre-energization of each of the processing sections based on the process specified by the specifying section.

### CROSS-REFERENCE TO RELATED APPLICATIONS

This Nonprovisional application claims priority under 35 U.S.C. §119(a) on Patent Application No. 2011-153111 filed in Japan on Jul. 11, 2011, the entire contents of which are hereby incorporated by reference.

### FIELD

The present invention relates to an image forming apparatus and a control method.

### BACKGROUND

In recent years, due to increased interests in environmental issues, products contributing to reduction in power consumption have been developed. For example, a power-saving module is mounted on an image forming apparatus such as a multifunction machine or a printer. The mode of the image forming apparatus having the power-saving function is switched to a power-saving mode to reduce the power consumption if a predetermined condition, such as the condition where the image forming apparatus is not used for a long period of time, is satisfied, even if a main power is turned on. When a predetermined condition, such as the condition where the user operates an operating unit, is satisfied, the mode of the apparatus is returned to a normal mode from the power-saving mode.

Various techniques have also been proposed for preventing the apparatus from wasting electrical power while the mode of the apparatus is returned from the power-saving mode to the normal mode.

Japanese Patent Application Laid-Open No. 2010-105235 discloses a printing apparatus that prohibits switching of modes leading to wasteful power consumption if there is a malfunction that disturbs a printing process when a processing instruction is received during the power-saving state. This printing apparatus checks the state of malfunction of the printing apparatus before switching the mode to the normal mode when a printing instruction is received during the power-saving mode, and compares malfunction information for the printing apparatus with a malfunction state inherent to a print job, to avoid repetition of mode switching.

Japanese Patent Application Laid-Open No. 2010-34749 discloses a processing apparatus that can change the manner of returning from the power-saving mode in accordance with a request from the user. The mode of this processing apparatus is returned from the power-saving mode only when the apparatus is operated in response to the user's request for switching the mode back from the power-saving mode. Moreover, only the mode of the apparatus required for the processing requested by the user is to be returned from the power-saving mode.

The conventional image forming apparatus including the power-saving module has an operation unit configured with hard keys, allowing an operation such as copy, scan or fax to be directly designated by each hard key even if a display unit is turned off during the power-saving mode. Recently, however, a liquid-crystal display apparatus with a touch screen in which a display unit and an operation unit are integrally formed is widely used for the image forming apparatus in response to a user's request for improving the user interface. In such an image forming apparatus having the liquid-crystal display apparatus, the user cannot directly designate an operation from the operation unit because the backlight of the liquid-crystal display apparatus is also turned off during the power-saving mode. When the mode of the apparatus is switched from the power-saving mode to the normal mode, all functional components are warmed up by energizing in advance in order to switch the mode of all the functions quickly to the operating state. Thus, unnecessary functional components are also energized, resulting in wasteful power consumption.

In another printing apparatus disclosed in Japanese Patent Application Laid-Open No. 2010-105235, all components are pre-energized when the mode of the apparatus is switched from the power-saving mode to the normal mode. Because a component not used is also unnecessarily pre-energized, the problem in the wasteful use of power cannot be solved. Japanese Patent Application Laid-Open No. 2010-34749 discloses a processing apparatus which needs to wait for a processing instruction to start pre-energizing, increasing the time required for executing the processing, and thereby lowering the processing efficiency.

### SUMMARY

The present invention has been made in view of the above circumstances. An object of the invention is to provide an image forming apparatus, a control apparatus and a control method that can shorten the time required for regaining power and can reduce wasteful power consumption for a part not required for the processing to be executed by the user during the returning period by stopping pre-energization of the unnecessary part.

An image forming apparatus according to the present invention includes: a plurality of processing sections each performing a different process; a switching section for switching the status of the apparatus from a normal status to a power-saving status which requires power consumption smaller than power consumption in the normal status when none of the plurality of processing sections performs processing for a predetermined period of time; a return section for making the mode of the apparatus return from the power-saving status to the normal status under a predetermined condition; a pre-energizing section for energizing each of the processing sections in advance when the mode of the apparatus is returned to the normal status; a specifying section for specifying a process to be executed; and a stop section for selectively stopping pre-energization of each of the processing sections based on the process specified by the specifying section.

In the present invention, the image forming apparatus includes a plurality of processing sections, a switching section, a return section, a pre-energizing section, a specifying section and a stop section. Each of the plurality of processing sections performs a different process. The switching section switches the status of the apparatus from the normal status to the power-saving status when none of the plurality of processing units performs processing for a predetermined period of time. The return section makes the mode of the apparatus return from the power-saving status to the normal status under a predetermined condition. During the returning period, the pre-energizing section energizes each processing section in advance. When a processing instruction is received, the specifying section specifies a process to be executed. The stop section selectively stops pre-energization of each of the processing sections based on the process specified by the specifying section.

The image forming apparatus according to the present invention further includes a selection section for selecting a component not required for execution of the process specified by the specifying section among components configuring each of the processing sections, wherein the stop section is configured to stop pre-energization of the component selected by the selection section.

According to the present invention, the image forming apparatus further includes the selection section. The selection section selects a component unnecessary for execution of the process specified by the specifying section among the components configuring each of the processing sections. The stop section stops pre-energization of the component selected by the selecting section.

The image forming apparatus according to the present invention further includes an operation unit for operating each of the plurality of processing sections; and a display unit for displaying information regarding an operation by the operation unit, wherein the display unit also serves as a part of the operation unit.

According to the present invention, the image forming apparatus includes an operation unit and a display unit. The operation unit operates each of the plurality of processing sections. The display unit also serves as a part of the operation unit and shows information regarding an operation performed by the operation unit.

In the image forming apparatus according to the present invention, the operation unit includes a soft key displayed on the display unit.

According to the present invention, the operation unit is provided with a soft key displayed on the display unit.

The image forming apparatus according to the present invention further includes an accepting section for accepting, from an external device, at least one of a returning instruction for making the status of the apparatus return to the normal status and a processing instruction for making the apparatus perform a process.

In the present invention, the image forming apparatus is further provided with an accepting section. The accepting section accepts, from an external device, a returning instruction for making the status of the apparatus return to the normal status and/or a processing instruction for making the apparatus perform a process.

A control device according to the present invention controls a to-be-controlled device provided with a plurality of processing sections each performing a different process, and includes: a switching section for switching the status of the to-be-controlled device from the normal status to the power-saving status which requires smaller power consumption than that in the normal status when none of the plurality of processing sections performs a process for a predetermined period of time; a return section for returning the status of the to-be-controlled device from the power-saving status to the normal status under a predetermined condition; a pre-energizing section for energizing each processing section in advance when the status of the to-be-controlled device is returned to the normal status; a specifying section for specifying a process to be executed by the to-be-controlled device; and a stop section for selectively stopping pre-energization of each processing section based on the process specified by the specifying section.

In the present invention, the control device includes a switching section, a return section, a pre-energizing section, a specifying section and a stop section. The switching section switches the status from the normal status to the power-saving status when none of the plurality of processing sections performs a process for a predetermined period of time. The return section makes the mode of the device return from the power-saving status to the normal status under a predetermined condition. During the returning period, the pre-energizing section energizes each processing section in advance. When the processing instruction is received, the specifying section specifies a process to be executed. The stop section selectively stops pre-energization of each processing section based on the process specified by the specifying section.

The control device according to the present invention further includes a selection section for selecting a component not required for execution of the process specified by the specifying section among components forming each of the processing sections. The stop section is configured to stop pre-energization of the component selected by the selection section.

In the present invention, the control device further includes a selection section. The selection section selects a component unnecessary for execution of the process specified by the specifying section among components forming each of the processing sections. The stop section stops pre-energization of the component selected by the selection section.

A control method according to the present invention is used to control a to-be-controlled device including a plurality of processing sections each performing a different process, and includes the steps of; switching the status of the to-be-controlled device from a normal status to a power-saving status which requires smaller power consumption than power consumption in the normal status when none of the plurality of processing sections performs a process for a predetermined period of time; returning the status of the to-be-controlled device from the power-saving status to the normal status under a predetermined condition; pre-energizing each of the processing sections when the status of the to-be-controlled device is returned to the normal status; specifying a process to be executed by the to-be-controlled device; and selectively stopping pre-energization of each of the processing sections based on the process specified by the specifying step.

In the present invention, if none of the plurality of processing sections performs a process for a predetermined period of time, the status of the to-be-controlled device is switched from the normal status to the power-saving status, and is switched back from the power-saving status to the normal status under a predetermined condition. When the status of the to-be-controlled device is returned to the normal status, each processing section is pre-energized. A process to be executed by the to-be-controlled device is specified, and pre-energization of each processing section is selectively stopped based on the specified process.

The control method according to the present invention includes the step of selecting a component not required for execution of the process specified by the specifying step among the components configuring each processing section. In the step of stopping, pre-energization of the component selected by the selecting step is stopped.

In the present invention, a component unnecessary for execution of the specified process is selected among the components configuring each processing section, and pre-energization of the selected component is stopped.

In the present invention, pre-energization of each processing section is selectively stopped based on the process to be executed after the status is returned to the normal status, so that a processing job can be executed at the time point when pre-energization of the component required for the process to the executed is completed. This can shorten the time required for returning and can suppress power consumption. Moreover, since no pre-energizing operation is performed for the component unnecessary for the process to be executed, the life span of a consumable part can be extended. Since pre-energization of the component not required for the process to be executed is stopped during the returning period, it is unnecessary to wait for the processing instruction to start pre-energization. This can shorten the time required for execution of a process, improving the processing efficiency.

The above and further objects and features of the invention will more fully be apparent from the following detailed description with accompanying drawings.

### BRIEF DESCRIPTION OF DRAWINGS

FIG. 1 is a schematic view illustrating an image forming apparatus according to Embodiment 1 of the present invention;

FIG. 2 is a block diagram illustrating the internal configuration of the image forming apparatus according to Embodiment 1 of the present invention;

FIG. 3 is a schematic view illustrating an example of an operation unit and a display unit of the image forming apparatus according to Embodiment 1 of the present invention;

FIG. 4 is a block diagram illustrating the internal configuration of a control unit of the image forming apparatus according to Embodiment 1 of the present invention;

FIG. 5 is a schematic view illustrating an example of a display screen of the display unit when a scanning process is executed;

FIG. 6 is a flowchart illustrating a control procedure of pre-energization of the image forming apparatus according to Embodiment 1 of the present invention; and

FIG. 7 is a block diagram illustrating the internal configuration of a control unit of an image forming apparatus according to Embodiment 2 of the present invention.

### DESCRIPTION OF PREFERRED EMBODIMENTS

### Embodiment 1

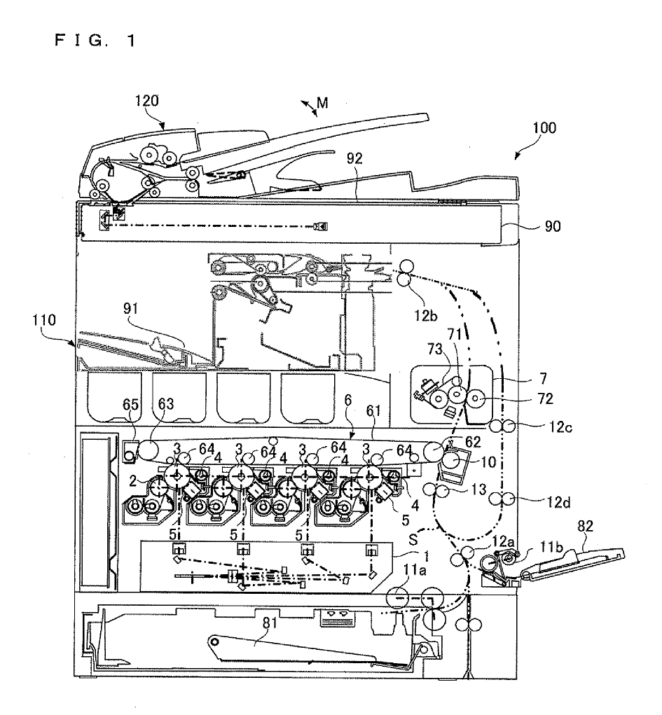

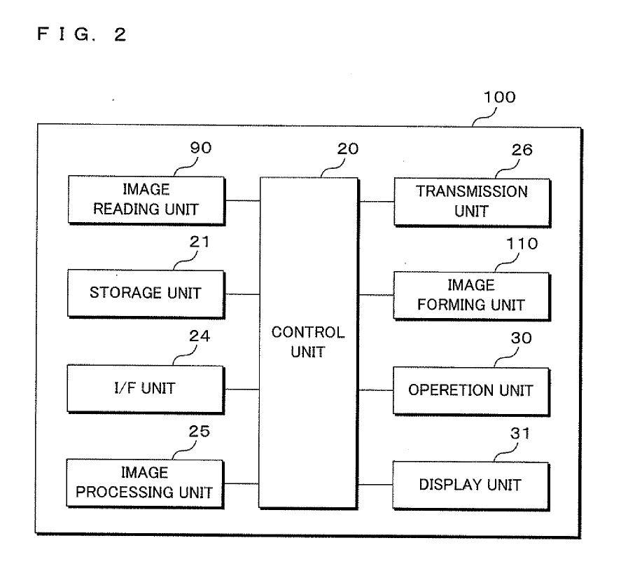

FIG. 1 is a schematic view illustrating an image forming apparatus 100 according to Embodiment 1 of the present invention. The image forming apparatus 100 can form a multiple or single color image on a predetermined sheet (recording paper) based on, for example, image data transmitted from the outside. The image forming apparatus 100 includes an image reading unit 90, an image forming unit 110, an automatic document conveying unit 120, a paper-feeding cassette 81, a manual paper-feeding cassette 82, a paper-receiving tray 91, a control unit 20 (see FIG. 2) for controlling the operation of the entire image forming apparatus 100, and an operation unit 30 (see FIG. 2) for performing operation and various setting for the entire image forming apparatus 100. The image forming unit 110 includes an exposure unit 1, a developer 2, a photosensitive drum 3, a cleaner unit 4, a charger 5, an intermediate transfer belt unit 6 and a fuser unit 7. The image forming apparatus 100 is a digital multifunction machine having a copying function and a facsimile function in addition to a printer function.

The image forming unit 110 is provided with the image reading unit 90 at the upper part thereof. The upper surface of the image reading unit 90, i.e. the upper surface of the image forming unit 110, serves as a document table having a transparent glass surface on which a document is placed. The image reading unit 90 has a scanning unit which moves back and forth in parallel with and along the lower surface of the document table 92, an imaging lens, a charge coupled device (C CD) line sensor and the like. The image reading unit 90 outputs data, obtained by separating the color image read from a document into color components of R (red), G (green) and B (blue), to the control unit 20. The automatic document conveying unit 120 is attached to the upper side of the document table 92. The automatic document conveying unit 120 automatically conveys a document to the document table 92. The automatic document conveying unit 120 is configured to freely rotate in the direction of the arrow M. A document can be manually placed on the document table 92 by opening the automatic document conveying unit 120.

The image data formed at the image forming apparatus 100 corresponds to the color image using colors of black (K), cyan (C), magenta (M) and yellow (Y). Thus, four sets of the developers 2, photosensitive drums 3, chargers 5 and cleaner units 4 are provided so as to form four types of latent images corresponding to the respective colors, forming four image stations for black, cyan, magenta and yellow.

The charger 5 is a charging unit for uniformly charging the surface of the photosensitive drum 3 at a predetermined potential. Other than the charger type illustrated in FIG. 1, a roller or brush charger of a contact type may alternatively be used.

The exposure unit 1 is configured as a laser scanning unit (LSU) provided with a laser emitting portion, a reflection mirror and the like. In the exposure unit 1, a polygon mirror scanning the laser beam and an optical element such as a lens and a mirror for leading the laser light reflected by the polygon mirror to the photosensitive drum 3 are placed. Alternatively, EL and LED write heads in which light emitting devices are aligned in an array may be used as the exposure unit 1.

The exposure unit 1 has a function of exposing the charged photosensitive drum 3 in accordance with input image data to form an electrostatic latent image corresponding to the input image data on the surface of the photosensitive drum 3. The developer 2 develops an image with toner of four colors (YMCK) from the latent image formed on the corresponding photosensitive drum 3. Moreover, the cleaner unit 4 removes and collects the toner remaining on the surface of the photosensitive drum 3 after development and image transfer.

The intermediate transfer belt unit 6 arranged above the photosensitive drum 3 includes an intermediate transfer belt 61, an intermediate transfer belt driving roller 62, an intermediate transfer belt driven roller 63, intermediate transfer rollers 64 and an intermediate transfer belt cleaning unit 65. Four intermediate transfer rollers 64 are provided corresponding to respective colors of YMCK.

The intermediate transfer belt driving roller 62, intermediate transfer belt driven roller 63 and intermediate transfer rollers 64 stretch and rotate the intermediate transfer belt 61. In addition, each intermediate transfer roller 64 applies a transfer bias for transferring a toner image on the photosensitive drum 3 to the intermediate transfer belt 61.

The intermediate transfer belt 61 is provided to be in contact with each photosensitive drum 3. The toner image of each color formed on the photosensitive drum 3 is sequentially transferred one over another to the intermediate transfer belt 61, to form a color toner image (multi-color toner image) on the intermediate transfer belt 61. The intermediate transfer belt 61 is formed in an endless manner using, for example, a film having a thickness of approximately between 100 μm and 150 μm.

The toner image is transferred from the photosensitive drum 3 to the intermediate transfer belt 61 by the intermediate transfer roller 64 which is in contact with the back side of the intermediate transfer belt 61. The intermediate transfer roller 64 is applied with a high-voltage transfer bias (high voltage having a polarity (+) opposite to the charge polarity (−) of the toner) in order to transfer the toner image. The intermediate transfer roller 64 has a shaft of metal (stainless steel, for example) having a diameter between 8 and 10 mm as a base, which is covered with a conductive elastic material such as EPDM, urethane foam and the like. The conductive elastic material allows the intermediate transfer belt 61 to be uniformly applied with high voltage. Though a transfer electrode of a roller type is used in the present embodiment, a brush type or the like may alternatively be used.

The latent image developed on the photosensitive drum 3 as described above in accordance with each hue is layered on the intermediate transfer belt 61. As the intermediate transfer belt 61 rotates, the layered image information is transferred to a sheet by a transfer roller 10 located at the position that makes the sheet in contact with the intermediate transfer belt 61. Here, the intermediate transfer belt 61 and the transfer roller 10 are pressed to be in contact with each other by a predetermined nip, while voltage (high voltage of polarity (+) opposite to the charge polarity (−) of the toner) for transferring toner to a sheet is applied to the transfer roller 10. In order for the transfer roller 10 to constantly obtain the nip, either one of the transfer roller 10 and the intermediate transfer belt driving roller 62 is made of a hard material (metal or the like), while the other one of them is made of a soft material (elastic rubber roller, expandable resin roller or the like).

Moreover, the toner adhered to the intermediate transfer belt 61 by touching the photosensitive drum 3 or the toner remaining on the intermediate transfer belt 61 without being transferred on a sheet by the transfer roller 10 is removed and collected by the intermediate transfer belt cleaning unit 65 because it may cause mixing of toner colors in the subsequent step. The intermediate transfer belt cleaning unit 65 is provided with, for example, a cleaning blade as a cleaning member which is in contact with the intermediate transfer belt 61. The portion of the intermediate transfer belt 61 where the cleaning blade touches is supported from the backside by the intermediate transfer belt driven roller 63.

The paper-feeding cassette 81 is a tray for storing sheets (recording paper) to be used for image forming and is provided under the exposure unit 1 of the image forming unit 110. Furthermore, a sheet to be used for image formation can also be placed on the manual paper-feeding cassette 82. The paper-receiving tray 91 arranged at the central part of the image forming unit 110 is a tray for collecting printed sheets facing down.

The image forming unit 110 is further provided with a substantially-vertical paper conveying path S for feeding a sheet on the paper-feeding cassette 81 or the manual paper-feeding cassette 82 to the paper-receiving tray 91 through the transfer roller 10 and the fuser unit 7. Pickup rollers 11a and 11b, conveying rollers 12a to 12d, a resist roller 13, the transfer roller 10, the fuser unit 7 and the like are arranged near the paper conveying path S from the paper-feeding cassette 81 or manual paper-feeding cassette 82 to the paper-receiving tray 91.

Each of the conveying rollers 12a to 12d is a small roller for accelerating and assisting conveyance of sheets. Plural conveying rollers 12a to 12d are arranged along the paper conveying path S. Furthermore, the pickup roller 11a is arranged near the end of the paper-feeding cassette 81, from which the pickup roller 11a picks up sheets one by one to feed them to the paper conveying path S. Similarly, the pickup roller 11b is arranged near the end of the manual paper-feeding cassette 82, from which the pickup roller 11b picks up sheets one by one to feed them to the paper conveying path S.

The resist roller 13 is to once hold a sheet conveyed on the paper conveying path S, and has a function of conveying the sheet to the transfer roller 10 at timing when the edge of a toner image on the photosensitive drum 3 is aligned with the edge of the sheet.

The fuser unit 7 includes a heat roller 71 and a pressure roller 72, which rotate with a sheet sandwiched in between. Moreover, the heat roller 71 is set to have a predetermined fusing temperature by the control unit 20 based on a signal from a temperature detector (not shown) and has a function of melting, mixing and pressurizing a multi-color toner image transferred to the sheet by working together with the pressure roller 72 to transfer the toner by heat pressure to the sheet and thereby heat-fixing the image on the sheet. Furthermore, an external heating belt 73 is provided for heating the heat roller 71 from the outside.

A sheet conveying path will be described below. As described above, the image forming apparatus 100 is provided with a paper-feeding cassette 81 and a manual paper-feeding cassette 82 for placing sheets in advance. In order to feed sheets from these paper-feeding cassettes 81 and 82, each of the pickup rollers 11a and 11b is arranged to lead the sheets one by one to the conveying path S.

The sheet conveyed from each of the paper-feeding cassettes 81, 82 is conveyed by the conveying roller 12a of the paper-conveying path S to the resist roller 13 and is conveyed to the transfer roller 10 at timing when the edge of the sheet is aligned with the edge of image information on the intermediate transfer belt 61. Here, image information is written on the sheet. Thereafter, the sheet passes through the fuser unit 7 where not-yet-fixed toner on the sheet is melted and fixed, and comes out to the paper-receiving tray 91 through the conveying roller 12b arranged subsequent to the fuser unit 7.

FIG. 2 is a block diagram illustrating the internal configuration of the image forming apparatus 100 according to Embodiment 1 of the present invention. The image forming apparatus 100 is provided with the control unit 20 described above including, for example, a CPU (Central Processing Unit) which performs various types of operation processing. The control unit 20 is connected to an image reading unit 90, a storage unit 21 such as a HDD (Hard Disk Drive), I/F unit 24, an image processing unit 25, a transmission unit 26, an image forming unit 110, an operation unit 30 and a display unit 31 through an internal bus (not shown). The control unit 20 is configured to control the operation of each of the hardware units and to be supplied with power even if the main power of the image forming apparatus 100 is turned off.

The image reading unit 90 is used to process, for example, the scanning function, facsimile function and copying function, and to perform photoelectric conversion on the light reflected from a document with a CCD line sensor to convert the obtained analog signal into a digital signal with an A/D converter. The image reading unit 90 performs correction on the digital signal obtained by the conversion for the orientation characteristic of a light source at the time of reading the document, irregularity in sensitivity for the image sensor, and the like. The obtained image data is stored in the storage unit 21 by control of the control unit 20. In the storage unit 21, image data obtained through the I/F unit 24 from a PC or the like is also stored.

The image processing unit 25 is used to process, for example, the copying function and the printing function. It generates data for image forming, which is used to control semiconductor laser light for forming an electrostatic latent image on the surface of the photosensitive drum, on each sheet (recording paper), and temporarily stores the generated data in a buffer memory (not shown).

The transmission unit 26 is used to process, for example, the facsimile function, and is configured to transmit image data stored in the storage unit 21 through the I/F unit 24.

The image forming unit 110 is used to process, for example, the copying function and the printing function, and forms an image on a sheet (recording paper) by control of the control unit 20, based on the data for image forming which is stored in the buffer memory. The conveyance of the sheet (recording paper) is controlled by the control unit 20.

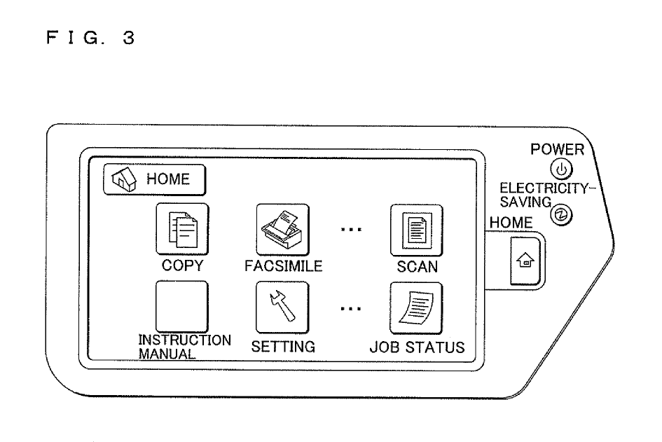

The operation unit 30 performs operation and various setting for the entire image forming apparatus 100. The display unit 31 is formed of a liquid-crystal display and the like, to display information regarding the operation performed by the operation unit 30. FIG. 3 is a schematic view illustrating an example of the operation unit 30 and the display unit 31 of the image forming apparatus 100 according to Embodiment 1 of the present invention.

As shown in FIG. 3, the operation unit 30 has various operation keys including a power key for turning on/off the power, an electricity-saving key for switching between a power-saving mode and a normal mode, a home key for jumping to an operation home and a soft key for selecting a function and an operation mode displayed on the display unit 31. The user can operate the operation unit 30 to give different instructions for regaining power, performing a process and the like. The display unit 31 has a touch screen also serving as a part of the operation unit 30 to display an operation screen, a content operated by the operation unit 30 and information regarding an operating condition of the entire device. FIG. 3 illustrates an operation screen shown on the display unit 31 when the user presses the home key of the operation unit 30. The user can designate a function such as copy, scan, facsimile or an operation mode by pressing a soft key indicating “copy,” “facsimile,” “scan,” “instruction manual,” “setting,” “job status” or the like.

The image forming apparatus 100 has a so-called power-saving function. In other words, even if the main power is turned on, the status of the apparatus 100 is switched from the normal status to the power-saving status where the power consumption is smaller than the normal status when the processing of print, copy, scan or facsimile has not been executed for a predetermined period of time, so that the power consumption is restricted. More specifically, only the control device 20, I/F unit 24, storage unit 21, touch screen of display unit 31 are energized, while the image reading unit 90, image processing unit 25, image forming unit 110, transmission unit 26, display unit 31 and the like are turned off. This switches the mode of the image forming apparatus 100 from the normal mode to the power-saving mode. Furthermore, the image forming apparatus 100 returns from the power-saving status to the normal status under a predetermined condition, so as to be able to execute the processing of print, copy, scan, facsimile and the like. More specifically, the image reading unit 90, image processing unit 25, image forming unit 110, transmission unit 26, display unit 31 and the like are turned on, allowing the image forming apparatus 100 to return from the power-saving mode to the normal mode. The predetermined condition here may include, for example, the user touching the touch screen of the display unit 31 while the light of the display unit 31 is turned off, the user pressing the electricity-saving key on the operation unit 30, or reception of a processing job from a PC, which is an external device.

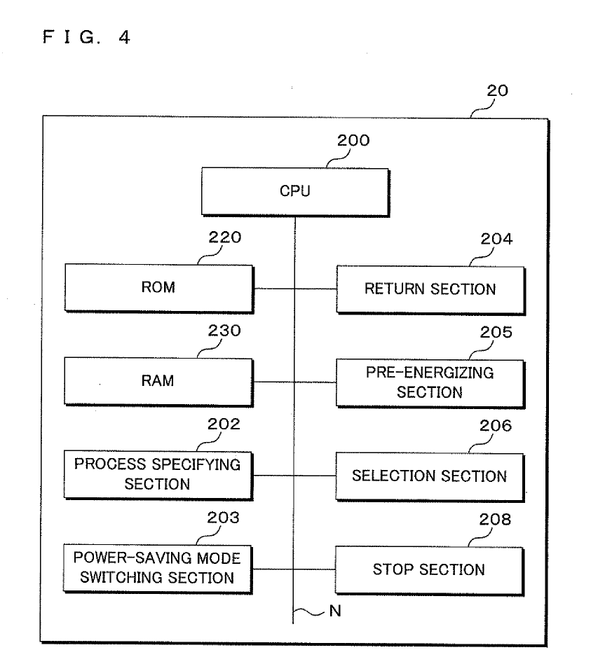

FIG. 4 is a block diagram illustrating the internal configuration of the control unit 20 of the image forming apparatus 100 according to Embodiment 1 of the present invention. As shown in FIG. 4, the control unit 20 includes a CPU 200, a ROM 220, a RAM 230, a process specifying section 202, a power-saving mode switching section 203, a return section 204, a pre-energizing section 205, a selection section 206 and a stop section 208.

The CPU 200 controls the operation of the entire control unit 20 via a bus N. The ROM 220 stores in advance a control program indicating a controlling procedure for the control unit 20. The CPU 200 loads the control program stored in the ROM 220 to the RAM 230, to allow the control unit 20 to control the operation of the image forming apparatus 100 in accordance with the controlling procedure indicated by the control program.

The process specifying section 202 is to specify the processing to be executed, and is configured to specify the processing for a function to be executed, when the user selects the function to be executed through the operation unit 30.

The power-saving mode switching section 203 turns off the power supplied to the image reading unit 90, image processing unit 25, image forming unit 110, transmission unit 26, display unit 31 and the like when processing has been performed by none of the image reading unit 90, image processing unit 25, image forming unit 110, transmission unit 26 and the like for a predetermined period of time, switching the mode of the image processing apparatus 100 from the normal mode to the power-saving mode.

The return section 204 turns on the image reading unit 90, image processing unit 25, image forming unit 110, transmission unit 26, display unit 31 and the like when the user touches the touch screen of the display unit 31 or when the user presses the electricity-saving key on the operation unit 30, to allow the mode of the image processing apparatus 100 to return from the power-saving mode to the normal mode.

The pre-energizing section 205 energizes in advance the image reading unit 90, image processing unit 25, image forming unit 110, transmission unit 26, display unit 31 and the like when the mode is returned to the normal mode. The pre-energizing here includes the process of energization or preparation performed when the power of the image processing apparatus 100 is turned on or when the power-saving mode is switched to the normal mode (where the apparatus can operate immediately in response to the user's operational instructions).

The selection section 206 is configured to select a component not required for executing the process specified by the process specifying section 202 among the components forming the image reading unit 90, image processing unit 25, image forming unit 110, transmission unit 26 and the like.

The stop section 208 selectively stops pre-energization of the image reading unit 90, image processing unit 25, image forming unit 110, transmission unit 26, display unit 31 and the like based on the process specified by the process specifying section 202. For example, it stops pre-energization of a component not required to be energized in advance among the components selected by the selection section 206.

Operation of the control unit 20 will be described below. In the image forming apparatus 100, the power is turned off for the image reading unit 90, image processing unit 25, image forming unit 110, transmission unit 26, display unit 31 and the like if none of the image reading unit 90, image processing unit 25, image forming unit 110, transmission unit 26 and the like operates for a predetermined period of time, and the normal mode is switched to the power-saving mode. In the power-saving mode, pre-energization is started for all the non-energized components in the image forming apparatus 100, such as the image reading unit 90, image processing unit 25, image forming unit 110, transmission unit 26 and the like, when, for example, the user touches the touch screen on the display unit 31. This allows the mode of the apparatus to return from the power-saving mode to the normal mode.

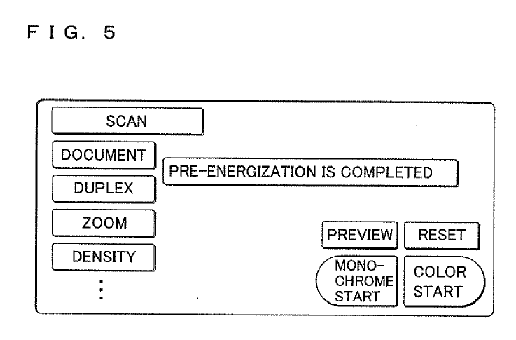

In the pre-energizing period, when the user selects the function of “scan” on the operation screen illustrated in FIG. 3, the screen shown in FIG. 5 is displayed on the display unit 31. FIG. 5 is a schematic view illustrating an example of a display screen of the display unit 31 when the scanning process is executed. As illustrated in FIG. 5, shortcut keys for setting and operational instruction keys, which can be operated by the touch screen function, are shown on the display unit 31. The user can operate the operation screen to instruct the processing to be executed. Moreover, when the pre-energizing operation is completed, information notifying that “pre-energization is completed” may be shown on the display unit 31. Here, if, for example, the user selects the function of “scan” on the operation screen shown in FIG. 3, the display is moved on to the operation screen for the “scan” as illustrated in FIG. 5, while the process specifying section 202 specifies the scanning process, the selection section selects components such as the exposure unit, developer, photosensitive drum as components not required for the instructed scanning processes, and the stop section 208 stops pre-energization of the components selected by the selection section 206.

When the user selects the copying function on the operation screen shown in FIG. 3, components in the image reading unit 90, image processing unit 25, image forming unit 110 stay pre-energized as these components are all required for copying. The pre-energization is stopped for the component forming the transmission unit 26 not required for the copying process.

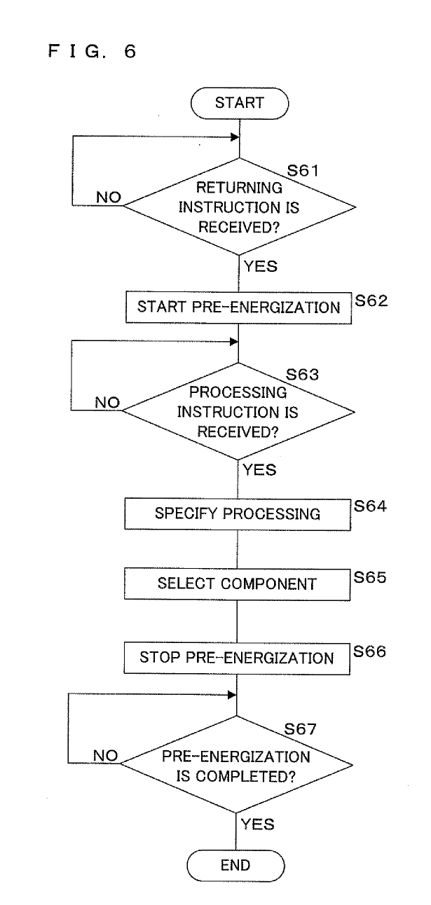

FIG. 6 is a flowchart illustrating the control procedure of pre-energization of the image forming apparatus 100 according to Embodiment 1 of the present invention. In the power-saving mode, the CPU 200 determines whether or not a returning instruction is received (step S61). If the CPU 200 determines that no returning instruction is received (step S61: NO), the determination is repeated until the returning instruction is received. If it is determined that the returning instruction is received (step S61: YES), the CPU 200 instructs the start of pre-energization so that all the functions in the image forming apparatus 100 can operate. The pre-energizing section 205 starts pre-energization of the image reading unit 90, image processing unit 25, image forming unit 110, transmission unit 26 and the like in accordance with the instructions from the CPU 200 (step S62).

The CPU 200 determines whether or not a processing instruction such as “copy,” “scan” or the like, selected by the user at the operation unit 30, is received (step S63). If the CPU 200 determines that no processing instruction is received (step S63: NO), it repeats the determination until a processing instruction is received. If the CPU 200 determines that a processing instruction is received (step S63: YES), it gives an instruction for specifying the processing regarding the received processing instruction.

The process specifying section 202 specifies the processing regarding the processing instruction such as “copy,” “scan” or the like in accordance with the instructions from the CPU 200 (step S64). The CPU 200 gives an instruction for selecting a component. The selection section 206 selects a component not required for executing the processing specified by the process specifying section 202 among the components forming the image reading unit 90, image processing unit 25, image forming unit 110, transmission unit 26, display unit 31 and the like (step S65), and instructs the stop section 208 to stop pre-energization of the selected component.

The stop section 208 stops pre-energization of the component specified at the selection section 206 in accordance with the instructions from the CPU 200 (step S66).

The CPU 200 determines whether or not pre-energization is completed for all the components (step S67). If it is determined that not all of the components are pre-energized (step S67: NO), the CPU 200 repeats the determination until pre-energization is completed for all the components. If it is determined that pre-energization is completed for all the components (step S67: YES), the mode of the function such as “copy,” “scan” or the like selected by the user is returned to the normal mode where the function is operable by pre-energization. This terminates the process of controlling pre-energization.

In the present embodiment, when the power-saving mode is switched to the normal mode, pre-energization of the component not required for the processing to be executed is stopped immediately after the processing instruction is specified, shortening the returning time and suppressing the electric power consumption. In addition, as the component unnecessary for the processing to be executed is not pre-energized, the life span of the components and consumable parts in the image forming apparatus 100 can be extended.

Furthermore, since pre-energization of the component not required for the processing to be executed is stopped during the returning period in the present embodiment, it is not necessary to wait for the processing instructions to start pre-energization. Thus, the time required for executing the processing is shortened while efficiency in the processing can be improved.

### Embodiment 2

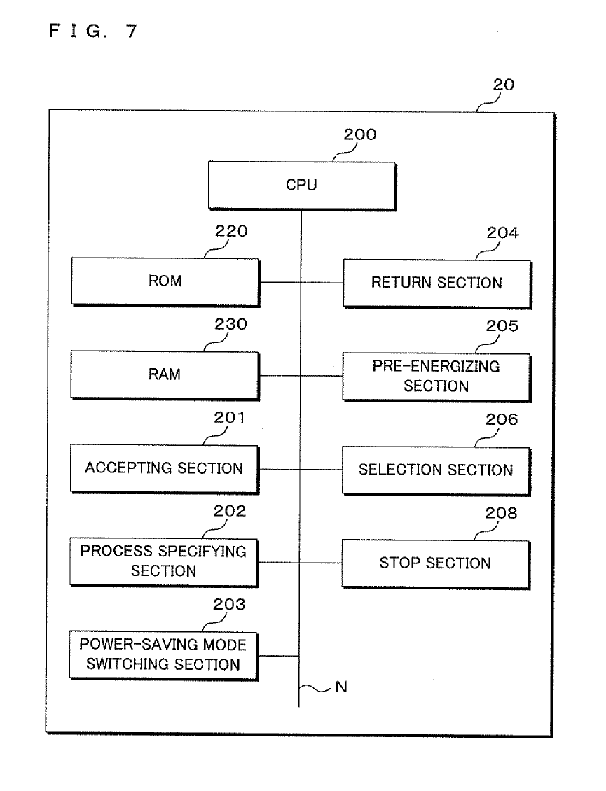

FIG. 7 is a block diagram illustrating the internal configuration of the control unit 20 of the image forming apparatus 100 according to Embodiment 2 of the present invention. As illustrated in FIG. 7, the control unit 20 in Embodiment 2 further includes an accepting section 201 for accepting various instructions from an external device, in addition to the configuration in Embodiment 1. Note that, in the description below, reference is made to Embodiment 1 for the configurations similar to those in

Embodiment 1, and such configurations will not be described in detail here. Moreover, the components similar to those in Embodiment 1 are denoted by the same reference codes as in Embodiment 1.

The accepting section 201 is configured to accept, from an external device, a returning instruction for making the mode of the apparatus return to the normal mode and/or a processing instruction for making the apparatus perform the processing such as print, scan or the like. In the present embodiment, the accepting section 201 is configured to accept a processing job transmitted from an external device, i.e. PC or the like, in the power-saving mode as the returning instruction for making the mode of the apparatus return from the power-saving mode to the normal mode and the processing instruction for making the apparatus perform the processing.

The process specifying section 202 specifies the processing regarding execution of the received processing job when the processing instruction from an external device is accepted.

The return section 204 is configured to turn on the power for the image reading unit 90, image processing unit 25, image forming unit 110, transmission unit 26, display unit 31 and the like when the returning instruction is accepted by the accepting section 201, to allow the mode of the image forming apparatus 100 to return from the power-saving mode to the normal mode.

The pre-energizing section 205 is configured to energize in advance the image reading unit 90, image processing unit 25, image forming unit 110, transmission unit 26, display unit 31 and the like when the mode of the apparatus returns to the normal mode.

The selection section 206 is configured to select a component not required for executing the processing specified by the process specifying section 202 among the components forming the image reading unit 90, image processing unit 25, image forming unit 110, transmission unit 26 and the like in accordance with the received command and/or data.

The stop section 208 selectively stops pre-energization of the image reading unit 90, image processing unit 25, image forming unit 110, transmission unit 26 and the like based on the processing specified by the process specifying section 202.

As the present embodiment includes the accepting section 201 for accepting the returning instruction for making the mode of the apparatus return to the normal mode and/or the processing instruction for making the apparatus perform a process from an external device, control of the pre-energization of the image forming apparatus 100 can be enhanced in terms of convenience.

Though Embodiments 1 and 2 above described examples where the control unit 20 is applied to the image forming apparatus 100, it is not limited thereto. The control unit 20 of the present invention can alternatively be applied to other devices with the power-saving function, such as a multifunction machine, an industrial machine and a medical device.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An image forming apparatus, comprising:
a plurality of processing sections each performing a different process;
a switching section for switching a status of the apparatus from a normal status to a power-saving status which requires power consumption smaller than power consumption in the normal status when none of the plurality of processing sections performs processing for a predetermined period of time;
a return section for making the status of the apparatus return from the power-saving status to the normal status under a predetermined condition;
a pre-energizing section for energizing each of the processing sections in advance when the status of the apparatus is returned to the normal status;
a specifying section for specifying a process to be executed; and
a stop section for selectively stopping pre-energization of each of the processing sections based on the process specified by the specifying section.

2. The image forming apparatus according to claim 1, further comprising a selection section for selecting a component not required for execution of the process specified by the specifying section among components configuring each of the processing sections, wherein
the stop section is configured to stop pre-energization of the component selected by the selection section.

3. The image forming apparatus according to claim 1, further comprising:
an operation unit for operating each of the plurality of processing sections; and
a display unit for displaying information regarding an operation by the operation unit, wherein
the display unit also serves as a part of the operation unit.

4. The image forming apparatus according to claim 1, further comprising an accepting section for accepting, from an external device, at least one of a returning instruction for making the status of the apparatus return to the normal status and a processing instruction for making the apparatus perform a process.

5. A control method for controlling a to-be-controlled device including a plurality of processing sections each performing a different process, comprising the steps of:
switching the status of the to-be-controlled device from a normal status to a power-saving status which requires smaller power consumption than power consumption in the normal status;
making the status of the to-be-controlled device return from the power-saving status to the normal status under a predetermined condition;
pre-energizing each of the processing sections when the status of the to-be-controlled device is returned to the normal status;
specifying a process to be executed by the to-be-controlled device; and
selectively stopping pre-energization of each of the processing sections based on the process specified by the specifying step.
